(19) United States
(12) Patent Application Publication
(10) Pub. No.: US 2004/0098639 A1
(43) Pub. Date: May 20, 2004

(54) Debugging kernel-loadable modules and suspending and replacing functions in non-microkernel operating systems

(76) Inventor: Bao Gang Liu, Beijing (CN)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/295,254

(22) Filed: Nov. 14, 2002

(51) Int. Cl. H02H 3/05; G06F 15/00; G06F 9/44

(52) U.S. Cl. 714/35; 712/227; 712/244; 717/129

(57) ABSTRACT

A debugger is implemented for kernel-loadable modules (180) under non-microkernel operating systems (160), using an interface provided by a kernel (160) on the target machine (110). A module debugger debugs kernel-loadable modules (180), in which the operating system kernel (160) executes normally and the functionality and capabilities of the operating system kernel (160) are maintained. The source code of the kernel (160) does not need to be known to or modified by the debugger, making the module debugger suitable for use under proprietary operating systems (160).

### FIELD OF THE INVENTION

The present invention relates to debugging kernel-loadable modules in non-microkernel operating systems, and to selectively suspending and replacing functions in a kernel-loadable operating system.

### BACKGROUND

Most processes executing on non-microkernel operating systems comprise two parts: (i) a user part that executes under the user space of the operating system, and (ii) a kernel part that executes in privilege mode in the kernel. A kernel thread is a process only having a kernel part, rather than a user part. Kernel-loadable modules under a non-microkernel operating system execute or run in the context of the kernel parts of processes or kernel threads.

The kernel of operating systems generally provide mechanisms for controlling the execution of user parts of processes, so that application debuggers can debug these user parts. There are also kernel debuggers with execution control functions that can debug kernel-loadable modules. These kernel debuggers, however, make the kernel unusable during debugging. Further, the source code of the kernel must be available to implement these kernel debuggers. An existing problem relates to determining how to debug kernel-loadable modules under non-microkernel operating systems, without stopping the kernel during debugging. This problem arises as the kernel source code of the operating system is often proprietary, and not generally available to the kernel debugger.

There are debuggers available for many operating system kernels. Examples include kdb/kgdb/xmon for Linux, kdb for AIX™ and OS/2™, kadb for SunOS™, kdebug for Digital UNIX, and WinDBG for Windows NT™ operating systems. In each case, these debuggers halt execution of the kernel during debugging. Also, the kernel source code is changed when these debuggers are implemented. Consequently, a third party that does not have access to the source code of the kernel cannot develop a debugger for the kernel or module. Another kind of kernel debugger includes as examples mdb for SunOS and kdbx for Digital UNIX. Debuggers of this kind can read and modify data of an active kernel, but do not support execution control of the kernel. That is, breakpoint and single-step control is not supported.

In view of the above observations, a need clearly exists for improved debuggers for debugging kernel-loadable modules in non-microkernel operating systems.

### SUMMARY

One feature of the present invention is to provide a debugger for debugging kernel-loadable modules of an operating system, in which the operating system executes normally, and existing functionality and capabilities of the operating system are maintained.

Another feature of the present invention is to debug an operating system while allowing the source code of the operating system kernel not to be known or modified.

A method is provided for debugging a kernel-loadable program module, in a data processing apparatus having a kernel-loadable operating system with a kernel exception handler. The method includes the steps of: receiving an exception while executing a kernel-loadable module; determining whether the exception is caused by a breakpoint condition in the kernel-loadable module; in response to determining that the exception is caused by a breakpoint condition in the kernel-loadable module, processing the exception using a predetermined exception handler other than the kernel exception handler; in response to determining that the exception is not caused by a breakpoint condition in the kernel-loadable module, processing the exception using the kernel exception handler; subsequent to processing the exception, branching to a location in memory from which the exception originated; and resuming execution of the kernel-loadable module.

A method is provided for debugging a kernel-loadable program module. The method includes the steps of: receiving an exception while executing a kernel-loadable module; determining whether the exception is caused by a breakpoint condition in the kernel-loadable module; in response to determining that the exception is caused by a breakpoint condition in the kernel-loadable module, changing the state of the kernel-loadable module to a suspended state while enabling other parts of the kernel to continue execution; debugging the kernel-loadable module; and, subsequent to debugging the kernel-lodable module, restoring the state of the kernel-loadable module to a non-suspended state. This method enables suspension of a module while debugging the module, while enabling other parts of the kernel to continue execution.

A method is provided for replacing the kernel exception handler of a kernel-loadable operating system with a predetermined exception handler, without accessing kernel source code of the operating system. The method includes the steps of: identifying first and second patchpoints in the execution path of the kernel exception handler for installing branching code; recording branching code at the first and second patchpoints for branching to the predetermined exception handler; and recording branching code in the predetermined exception handler for branching back to the kernel exception handler at the first patchpoint. When recording the branching code at the patchpoints in the exception handler, a portion of the original code is preferably replaced by the new branching code which overwrites the original code. This method enables dynamic replacement of the kernel exception handler without accessing kernel source code.

A fourth aspect of the invention provides a method for handling exceptions invoked in kernel space in a kernel-loadable operating system having a kernel exception handler. The method includes the steps of: in response to an exception event while executing a kernel-loadable module, which exception event indicates a requirement to suspend functions within the operating system kernel, changing the state of the kernel-loadable module to a suspended state while enabling the operating system kernel to continue execution; and processing the exception event using a replacement exception handler other than the kernel exception handler.

A fifth aspect of the invention provides a data processing apparatus including a kernel-loadable operating system having a kernel exception handler, the apparatus including: a debugger program for debugging kernel-loadable modules; and means, responsive to a determination that an exception is caused by a breakpoint condition in the kernel-loadable module, for changing the state of the kernel-loadable module to a suspended state while enabling other parts of the kernel to continue execution, and for invoking a replacement exception handler and the debugger program to process the exception.

### DESCRIPTION OF DRAWINGS

One or more embodiments of the present invention will now be described in more detail, by way of example, with reference to the accompanying drawings in which:

FIG. 1 is a schematic representation of an architecture of an operating system environment and a described module debugger, referred to herein as mdb.

FIG. 2 is a flowchart of steps involved in using a sleep mechanism to suspend execution of a module.

FIG. 3 is a schematic representation of an example debugging session using mdb.

FIG. 4 is a schematic representation of the order in which blocks of code are executed when an exception occurs.

FIG. 5 is a flowchart of steps that occur when an exception occurs, corresponding to the steps described with reference to FIG. 4.

### DETAILED DESCRIPTION

A module debugger, referred to herein simply as mdb, is described for debugging kernel-loadable modules without stopping the kernel of the operating system, or accessing the source code of the operating system. A dynamic instrumentation mechanism is used to implement mdb, without needing to access the kernel source code. The mdb can be inserted into and removed from an executing kernel without affecting the kernel's existing functionality.

The described module debugger can be implemented under non-microkernel operating systems with the support of kernel-loadable modules. A trap exception handler used with existing module debuggers is replaced with a modified exception handler. The functionality of existing trap exception handlers is retained.

When the module to be debugged (hereafter referred to as the ‘debugged module’) encounters a breakpoint (i.e. a breakpoint condition which triggers a breakpoint instruction—such as a condition indicating a need for debugging), the trap instruction is executed and the modified exception handler processes the trap exception. The modified exception handler allows the debugged module to continue execution following a new function that calls a sleep function provided by the kernel. This sleep function causes the process which called the debugged module to “sleep” (i.e. be changed to a suspended state). The module debugger may call a “wake up” function of the operating system kernel to “wake up” the debugged module following the sleep function. Then the debugged module and its calling process can continue execution.

When the debugged module encounters a breakpoint condition, the debugged module is suspended. Only the debugged module and its calling process are suspended, while all other parts of the kernel are unaffected.

The exception handler of the kernel is replaced for debugging only. The exception handler of the kernel is therefore changed without losing the functionality of the original exception handler. In an analogous manner, other functions in the kernel can also be replaced, such as for implementing a new trace function.

The module debugger uses replacement program code copied to two patchpoints within the operating system kernel's code path, to control the execution path when an exception is invoked. The original exception handler is selectively activated as appropriate (i.e. when an exception is not triggered by a breakpoint). The new program code which replaces code at the two patchpoints is used to branch to a memory location at which the module debugger code is located. Replacement code is inserted at the first patchpoint so as to overwrite the original code when the module debugger is loaded into the kernel. The program code inserted at this first patchpoint is used to branch to the new exception handler provided by the module debugger, for processing any exceptions invoked by a breakpoint. When the module debugger activates the original exception handler, execution control is returned to the original exception handler code at the first patchpoint.

In the context of the present specification, the ‘patchpoints’ are points within the binary program code of the kernel exception handler which are identifiable as suitable points for replacement of a portion of the code of the exception handler to modify the operation of the exception handler and enable branching in accordance with the invention.

Code inserted at the second patchpoint permits the module debugger to handle the next stage of execution after execution of the original exception handler, when appropriate. The module debugger then inserts the replacement program code at the first patchpoint again, so that the new exception handler provided by the module debugger can be branched to when the next exception occurs.

Identification of two suitable patchpoints will be described below, after a summary of exception handling in a typical operating system. Exception handling in a typical operating system involves the following steps:

[1] An exception is invoked;

[2] CPU execution jumps to a location (called Exception_Handling_Entry in the following) that is pointed to by an ‘exception vector table’ to execute;

[3] The code at Exception_Handling_Entry (typically written in assembly language) will first save the current CPU status, then

[4] Call a function (typically written in C programming language). This function can access information of the current process using a function provided by OS kernel, and can modify the status saved in step [3] to affect the operation in step [6].

[5] The C function in [4] will return to an address that is identified by step [3].

[6] Restore the CPU status saved in step [3] (possibly modified by [4]) and return to a position to continue run according to the CPU status.

The steps [3] and [6] are only used to ‘save CPU status when an exception is invoked’ and ‘restore CPU status’. The main work for handling the exception is done in step [4] where a policy is used to decide the fate of the process (or some other binary codes) where the exception is invoked.

So, to replace the original exception handler, the process followed is:

(a) set the first patchpoint in the code execution path before the C function in step [4] is called; and

(b) set the second patchpoint in the code execution path after the C function in step [4] is executed.

However, to avoid the mdb exception handler performing the work that is done by steps [3] and [6], an optimal location for the first patchpoint is between step [3] and [4], and an optimal location for the second patchpoint is between [5] and [6].

### Debugger Architecture

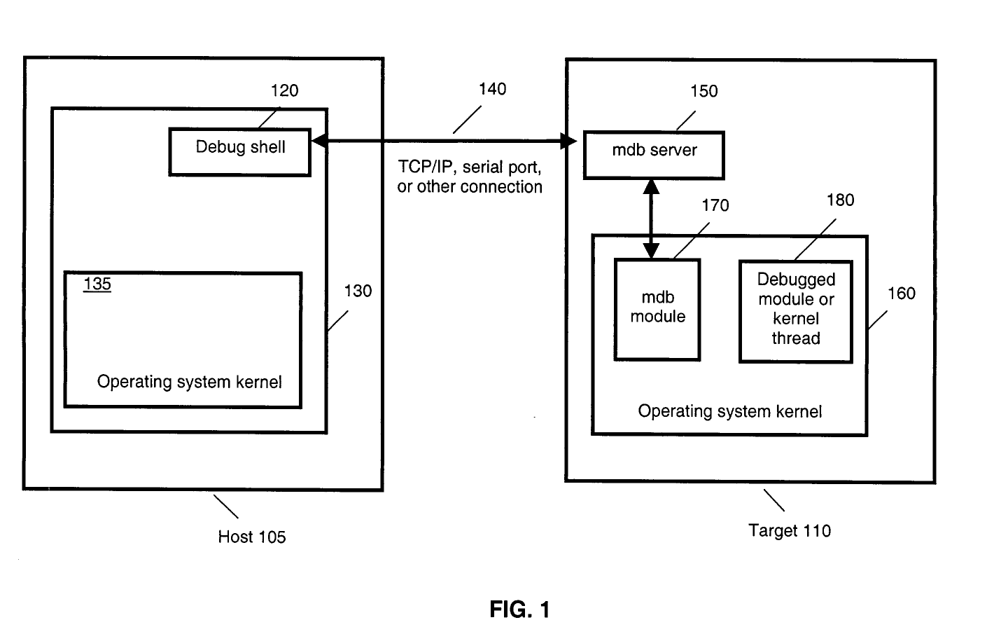

FIG. 1 schematically represents an architecture of the mdb, as the mdb operates in an operating system environment. With reference to FIG. 1, a host machine 105 and a target machine 110 communicate via a communications link 140. A debug shell 120 communicates with a mdb server 150 via this communications link 140. The debug shell 120 and operating system kernel 135 execute under operating system 130. The mdb server 150 communicates with an operating system kernel 160 on the target machine 110.

The operating system kernel 160 comprises a mdb module 170, and a debugged module or kernel thread 180. The mdb server 150 communicates directly with the mdb module 170 in the operating system kernel 160. The mdb server 150 is a process executing on the operating system of the target machine 110. The communications link 140 is used for communicating using TCP/IP protocols, a serial line connection or any other appropriate form of communication. The mdb server 150 receives a command from the debug shell 120, and controls the mdb module 170 to perform the requested operation. The mdb server 150 also obtains data from the mdb module 170, and returns this data to the debug shell 120. The debug shell 120 can also execute on the target machine, if necessary or appropriate.

The mdb module 170 is a kernel-loadable module of the operating system on the target machine 110. The mdb module 170 accepts commands from the debug shell 120. These commands are transferred via the mdb server 150. Examples of such commands are “memory read”, “single step” and “continue to run”.

The mdb server 150 sends a command from the debug shell 120 to the mdb module 170, and then transmits returned data from the mdb module 170 to the debug shell 120.

### Suspending Kernel-Loadable Module

When the debugged module 180 encounters a breakpoint, the operating system kernel 160 of system 110 branches from module 180 to a new position in code to continue execution, without modifying the value of any register. The binary code of the new position causes a sleep function provided by the kernel 160 to make the module 180 sleep.

An exception is invoked when the debugged module 180: (i) encounters a trap instruction or an illegal instruction, (ii) finishes executing an instruction in single-step mode, or (iii) induces a memory access error when accessing data or an instruction.

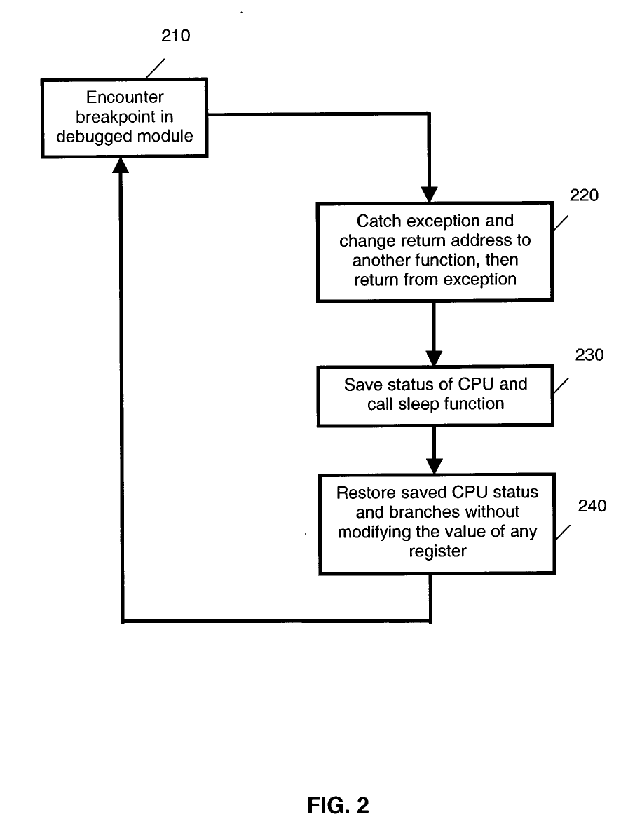

FIG. 2 flowcharts steps involved in using the above-described sleep mechanism to suspend the debugged module 180. The original exception handler of the operating system kernel 160 is replaced by the mdb without modifying the kernel source code.

In step 210, an exception is invoked as the debugged module 180 encounters a breakpoint. In step 220, this breakpoint is captured by the mdb's exception handler. The exception handler's return address is changed to a function 230 provided by the mdb 170. Accordingly, after the exception handler exits, the function 230 gets execution control.

In step 230, the status of the Central Processing Unit (CPU) is saved. The only difference in CPU status during steps 210 and 230 relates to the programme counter. The value of all other registers remains the same. After the CPU status is saved, the sleep function provided by the operating system kernel 160 is called to make the process calling the function of the debugged module 180 sleep.

Once this occurs, the mdb server 150 can accept commands from the debug shell 120, and sends these commands to the mdb module 170. After the mdb module 170 accepts a command to permit the debugged module 180 to continue to run, the mdb module 170 wakes up the sleep function in step 230.

In step 240, the saved CPU status is restored, then execution branches to the code 210 at which the breakpoint was triggered without modifying the value of any register. Once this occurs, the debugged module 180 continues to run from the breakpoint, with the same CPU status that existed immediately before the breakpoint was encountered in step 210.

### Dynamic Manipulation of Kernel

As previously described, the original exception handler is replaced by an mdb exception handler. The mdb exception handler, however, retains the option to use the functionality of the original exception handler. Particular exceptions are handled by the original exception handler, rather than the mdb exception handler, where appropriate.

An example of an exception of this type is one that arises from the user space, or the kernel space code outside of the debugged module. The mdb desirably only handles exceptions arising from the debugged module. That is, mdb does not debug code outside of the debugged module, to avoid affecting original kernel functions.

To replace the original exception handler, replacement code overwrites original code at a patchpoint associated with the original exception handler, so that the original exception handler will immediately branch to the mdb exception handler when an exception is invoked. Therefore, any exception is first handled by the mdb exception handler. When an exception is appropriately handled by the original exception handler, the original exception handler's code at the first patchpoint is restored, and the code of the original exception handler is invoked and executed. After the ‘restored’ original code is executed, execution control is returned to the branch instructions associated with the mdb exception handler, so that the mdb exception handler is able to process the two patchpoints and in particular the mdb exception handler can process the next exception. The second patchpoint in the original exception handler is used to achieve this objective, as described below.

When the mdb module 170 is inserted into the operating system kernel 160, the mdb module 170 finds two points in the execution path of the original exception handler for adding instructions that can branch to the mdb module's execution handler. In the original operating system kernel, when an exception occurs, the code first executed comprises a series of assembly instructions. A function in the C programming language is then called to handle the exception. The entry point of this C function and the return address of this C function is a candidate position for the insertion of replacement program code.

When the mdb module 170 is inserted into the operating system kernel 160, the mdb module 170 modifies the code at the first patchpoint using a series of codes that can branch to the mdb exception handler, and keeps the codes at the second patchpoint unchanged. When an exception that is appropriately handled by the original handler is invoked, the original code at the first patchpoint is restored before the original exception handler can be activated.

To make the mdb exception handler handle the next exception, replacement code is copied to the first patchpoint again after the original exception handler finishes execution. Before the original exception handler is executed, replacement code is copied to the second patchpoint to enable branching to a debugger memory location, so that after execution of the original exception handler, code copied to the second patchpoint is executed and permits the module debugger to get execution and then activate (copy replacement code to) the first patchpoint again.

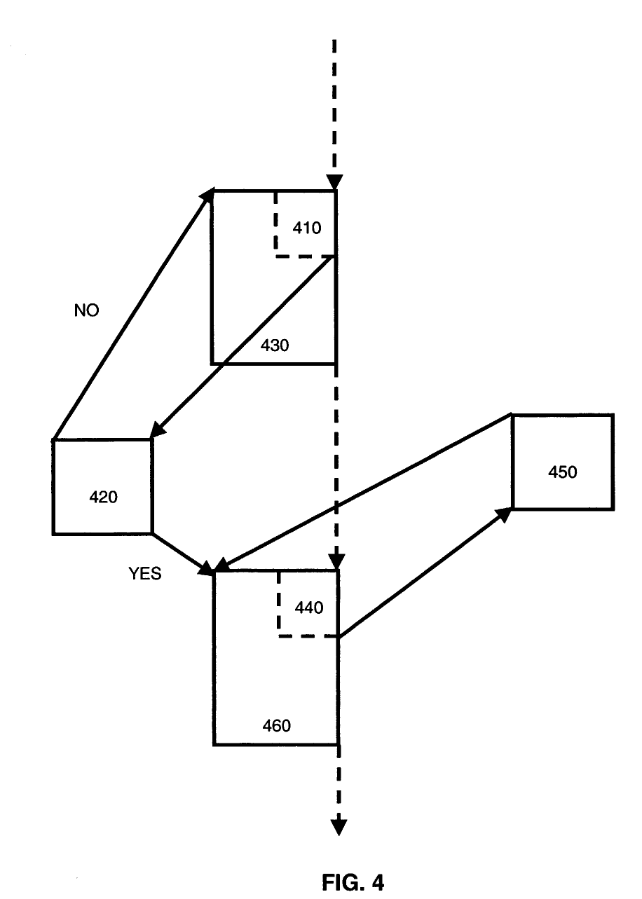

FIG. 4 schematically represents the execution path followed when an exception occurs. The code blocks represented in FIG. 4 represent blocks of code that are executed by a machine. Code block 430 and code block 460 represent code relating to the execution path of the original exception handler of the operating system kernel 160.

Code block 420 represents the mdb exception handler provided by the module debugger, for determining if the exception is appropriately handled by the mdb exception handler itself. Code block 450 represents code for a function provided by the mdb. Code portions 410 and 440 respectively represent portions of code blocks 430 and 460 where code for mdb_patch is copied, when appropriate. Code for mdb_patch in code portion 410 of code block 430 provides code for branching to code block 420. Correspondingly, code portion 440 of code block 460 provides code for branching to code block 450.

An integer array, referred to herein as mdb_patch, comprises a series of instructions for branching between code blocks. Each element in the mdb_patch array is an instruction. This array is copied to a memory location, and an instruction at another location is executed so that execution jumps to the above-mentioned location to which the array is copied. The relevant instruction in the array is consequently executed.

The instructions in mdb_patch branch to a new position, and either: (i) do not change values of all relevant registers; or (ii) save original values of changed relevant registers in a stack or other buffers. Original values are saved so that the instruction to which the mdb_patch branches can reinstall these saved original values.

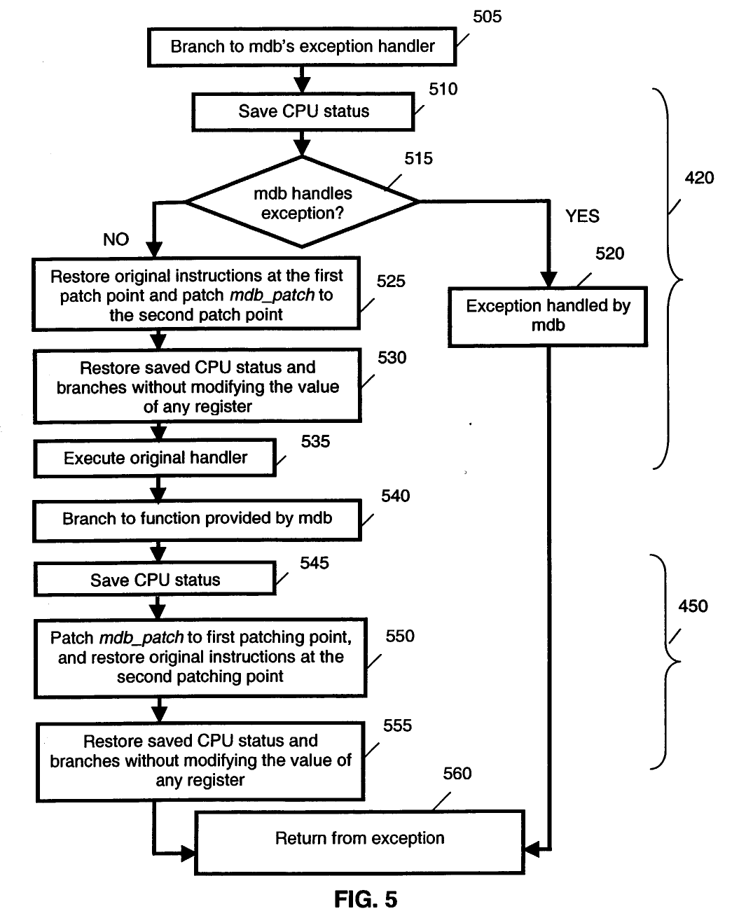

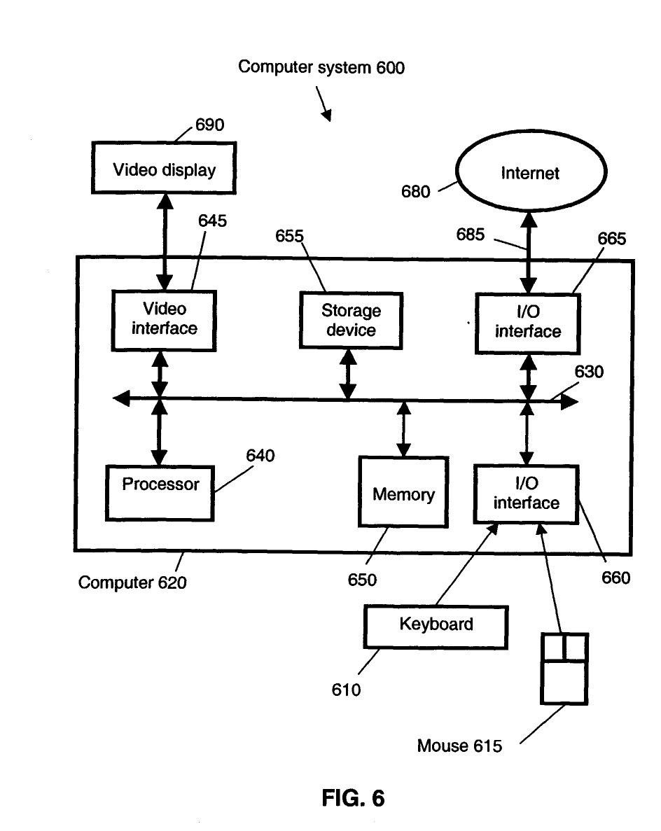

FIG. 5 flowcharts steps involved in handling an exception. With reference to FIG. 4, the execution path of the original exception handler passes from code block 430 (the position of the original exception handler) to code block 460, as represented by the dashed lines. Code portions 410 and 440 are respectively the first and second patchpoints at which new branching code is inserted to replace the original code. Code block 420 in FIG. 4 corresponds with steps 510 to 530 in FIG. 5. Code block 450 in FIG. 4 corresponds with steps 545 to 555 in FIG. 5.

In respect of FIGS. 4 and 5, code block 410 in FIG. 4 is the entry point of code block 430 and corresponds with step 505 in FIG. 5. Code block 410 is used to branch to a predetermined exception handler when an exception is invoked. Code block 430 in FIG. 4 corresponds with step 535 in FIG. 5. Code block 440 in FIG. 4 corresponds with step 540 in FIG. 5. Code block 460 in FIG. 4 corresponds with step 560 in FIG. 5.

With reference to FIG. 5, execution branches to the mdb's exception handler in step 505. In step 510 the current CPU status is saved. In step 515 code block 420 determines whether it is appropriate for the mdb to handle the current exception. If the exception is to be handled by the mdb, this occurs in step 520.

If, however, the mdb does not handle the current exception, the original instructions are restored at the first patchpoint; that is, at code portion 410 of code block 430 in FIG. 4. Also, mdb_patch is copied to the second patchpoint represented in FIG. 4 as code portion 440 of code block 460. In step 530, the CPU status saved in step 510 is restored.

In step 535, the execution path of the original exception handler is processed in code 10 block 430. That is, processing returns from code block 420 to code block 430. In step 540, execution passes to code portion 440 of code block 460, and execution then branches to a function provided by the mdb, represented as code block 450 in FIG. 4.

In step 545 the current CPU status is saved, in accordance with the code of code block is 450. In step 550, mdb_patch is copied to the first patchpoint, namely code portion 410 in code block 430. The original instructions at the second patchpoint, namely code portion 440 of code block 460, are restored. In step 555, the CPU status saved in step 545 is restored. The code block 450 branches to code block 460 without modifying the value of any register.

In step 560 execution returns back from exception processing. Where the original kernel exception handler processes the exception, returning from the exception is to a code position determined by that original exception handler.

As an alternative to performing steps 525 to 555, when the mdb exception handler handles the exception, after performing step 520 the processing passes directly to step 560. In this case, the predetermined exception handler changes the return address of the exception (returning to position 230 in FIG. 2, then 240 of FIG. 2, and then resuming execution of the debugged module).

When the mdb module 170 is inserted into the operating system kernel 160, the mdb module 170 first copies mdb_patch to the first patchpoint (code portion 410), so that the mdb_patch is executed when an exception is invoked. Consequently, processing branches to code block 420. Code block 420 determines whether the exception should be handled by mdb. If the exception is to be handled by the mdb, then after the mdb's exception handles the exception, processing returns from code block 460.

If the original exception handler is to handle the exception, the original instructions at the first patchpoint (code portion 410) are restored, and mdb_patch is copied to the second patchpoint (code portion 440). After the original exception handler completes its function in code block 430, the mdb_patch at the second patchpoint (code portion 440) jumps to a function provided by the mdb block 450. Then, the mdb_patch is copied to the first patchpoint (code portion 410), and the original instructions at the second patchpoint (code portion 440) are restored. The exception handler finishes execution once code block 460 is completed. Throughout this process, the mdb's exception handler can selectively handle exceptions while retaining the ability to use the original exception handler, if appropriate.

The method described here for dynamic replacement of a kernel exception handler can be used for dynamic replacement of other kernel functions, by making small changes to the method. In the above-described method, replacement code that is inserted at the first and the second patchpoint is used to branch to the new exception handler provided by the module debugger. In a modification of this method, the replacement code closes the interrupt before branching to the new exception handler, and the code in the new exception handler opens the interrupt which was closed by the replacement code after the code in the new exception handler is branched to by the replacement code. Using thids modified method, dynamic replacement of any kernel function is achieved.

### Debugging Section

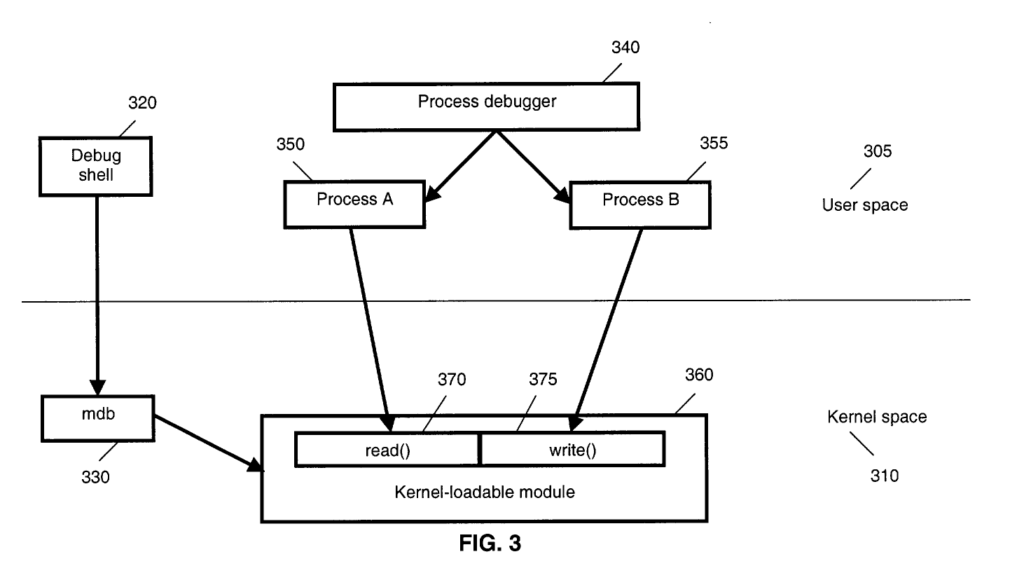

FIG. 3 schematically represents an example debugging session using mdb. Consider, as an example, a user wanting to debug the synchronization of read/write operations in a device driver accessed by a set communicating processes A and B, as depicted in FIG. 3. These processes are process A 350 and process B 355 which are debugged by process debugger 340. A debug shell 320 is also provided in the user space 305 for operating the mdb 330 in respect of a kernel-loadable module 360 in the kernel space 310.

The kernel-loadable module 360 comprises read( ) function 370 and write( ) function 375. The user can set breakpoint instructions in the read( ) function 370 and the write( ) function 375 of the device driver 360. Since the kernel is running, the user can also set an arbitrary running sequence for process A 350 and process B 355, for use in a synchronization test.

Various kernel tools, such as kernel-tracing tools, can be implemented using this dynamic instrumentation concept, as kernel source code need not to be accessible to the mdb.

### Process State Transition

At any time, a process executing in an operating system is in one of a number of defined states. The state of the process changes in response to operating system events. The running of the process is controlled by a process scheduler in the operating system kernel.

FIG. 6 schematically represents state transitions of a typical process state model. The six states in FIG. 6, (and transitions therebetween) are described as follows.

Running in kernel mode 620: A process whose kernel part is currently executing.

Running in user mode 650: A process whose user part is currently executing.

Ready 630: A process that is prepared to execute when given the opportunity.

Asleep 640: A process that cannot execute until woken up.

New 610: A process that has just been created but is not yet admitted for execution by the operating system.

Exit 660: A process that is released by the operating system.

FIG. 6 indicates the types of events that lead to each state transition for a process. Possible transitions are described as follows.

Null to New 610: A new process is created to execute a program.

New 610 to Ready 630: The operating system moves a process from the New state to the Ready state when the operating system is prepared to take on an additional process.

Ready 630 to Running in kernel mode 620: When a new process is selected to run, the process scheduler in the operating system chooses one of the processes in the Ready state.

Running in kernel mode 620 to Exit 660: The currently running process is terminated by the operating system if the process indicates that the process has completed, or if the process aborts.

Running in kernel mode 620 to Ready 630: After the current process has been running for a period of time, the process scheduler in the operating system moves the current process to Ready state, and provides a chance for other processes to execute.

Running in kernel mode 620 to Asleep 640: A process is put in the Asleep state if the process calls the sleep function. Normally, a process calls the sleep function if the process is waiting for something the process requested.

Asleep 640 to Ready 630: A process in the Asleep state is moved to the Ready state when the operating system wakes up the process. Operating system wakes up a process when whatever the process requested becomes available.

Ready 630 to Exit 660

Running in user mode 650 to Running in kernel mode 620: A process running in user mode becomes running in kernel mode if the process calls a system call or an exception occurs.

Running in kernel mode 620 to Running in user mode 650: A process running in kernel mode becomes running in user mode if the process returns from a system call or an exception.

### Computer Hardware and Software

FIG. 7 is a schematic representation of a computer system 700 that is provided for executing computer software programmed to assist in performing the techniques described herein. This computer software executes on the computer system 700 under a suitable operating system installed on the computer system 700.

The computer software is based upon computer program code comprising a set of programmed instructions that are able to be interpreted by the computer system 700 for instructing the computer system 700 to perform predetermined functions specified by those instructions. The computer program can be recorded in any suitable programming language and comprises a set of instructions intended to cause a suitable computer system to perform particular functions, either directly or after conversion to another programming language.

The computer program is processed, using a compiler, into computer software that has a binary format suitable for execution by the computer system. The computer software is programmed in a manner that involves various program code components, or code means, that perform particular steps in accordance with the techniques described herein.

The components of the computer system 700 include: a computer 720, input devices 710, 715 and video display 790. The computer 720 includes: processor 740, memory module 750, input/output (I/O) interfaces 760, 765, video interface 745, and storage device 755. The computer system 700 can be connected to one or more other similar computers, using a input/output (I/O) interface 765, via a communication channel 785 to a network 780, represented as the Internet.

The processor 740 is a central processing unit (CPU) that executes the operating system and the computer software executing under the operating system. The memory module 750 includes random access memory (RAM) and read-only memory (ROM), and is used under direction of the processor 740.

The video interface 745 is connected to video display 790 and provides video signals for display on the video display 790. User input to operate the computer 720 is provided from input devices 710, 715 consisting of keyboard 710 and mouse 715. The storage device 755 can include a disk drive or any other suitable non-volatile storage medium.

Each of the components of the computer 720 is connected to a bus 730 that includes data, address, and control buses, to allow these components to communicate with each other via the bus 730.

The computer software can be provided as a computer program product recorded on a portable storage medium. In this case, the computer software is accessed by the computer system 700 from the storage device 755. Alternatively, the computer software can be accessed directly from the network 780 by the computer 720. In either case, a user can interact with the computer system 700 using the keyboard 710 and mouse 715 to operate the computer software executing on the computer 720.

The computer system 700 is described only as an example for illustrative purposes. Other configurations or types of computer systems can be equally well used to implement the described techniques.

Various alterations and modifications can be made to the arrangements and techniques described herein, as would be apparent to one skilled in the relevant art.

1. A method for debugging a kernel-loadable program module, for a data processing apparatus having a kernel-loadable operating system with a kernel exception handler, the method comprising the steps of:
receiving an exception while executing a kernel-loadable module;
determining whether the exception is caused by a breakpoint condition in the kernel-loadable module;
in response to determining that the exception is caused by a breakpoint condition in the kernel-loadable module, processing the exception using a predetermined exception handler other than the kernel exception handler;
in response to determining that the exception is not caused by a breakpoint condition in the kernel-loadable module, processing the exception using the kernel exception handler;
subsequent to processing the exception, branching to a location in memory from which the exception originated; and
resuming execution of the kernel-loadable module.

2. A method according to claim 1, further comprising the step of branching to the predetermined exception handler in response to said step of receiving the exception, wherein the predetermined exception handler performs the step of determining whether the exception is caused by a breakpoint condition in the kernel-loadable module, and either processes the exception if caused by a breakpoint condition in the kernel-loadable module or branches to the kernel exception handler if not caused by a breakpoint condition in the kernel-loadable module.

3. A method according to claim 1, wherein the step of processing the exception using the predetermined exception handler comprises:
branching to a debugger memory location determined by the predetermined exception handler, to execute debugging code at the debugger memory location.

4. A method according to claim 3, further comprising the steps of:
saving original state information of the computer environment directly after said step of branching to the debugger memory location;
calling a sleep function to suspend said kernel-loadable module, while enabling other parts of the kernel to continue execution; and
restoring the original state of the computer environment after executing the debugging code and before resuming execution of the kernel-loadable module.

5. A method according to claim 1, further comprising the steps of:
inserting branching instructions at a first patchpoint and at a second patchpoint within the kernel exception handler, to enable branching to the predetermined exception handler before and after execution of the kernel execution handler respectively.

6. A method according to claim 5, including:
in response to receiving an exception while executing a kernel-loadable module, executing the branching instructions at the first patchpoint to branch to the predetermined exception handler;
in response to determining that the exception is caused by a breakpoint condition in the kernel-loadable module, processing the exception using the predetermined exception handler and then branching to a debugger memory location determined by the predetermined exception handler, to execute debugging code at the debugger memory location; and
in response to determining that the exception is not caused by a breakpoint condition in the kernel-loadable module, branching to the kernel exception handler to process the exception, and then returning execution control to code instructions within the debugging code as determined by the program code inserted at the second patchpoint, and then instructions within the debugging code activating the first patchpoint again so that the predetermined exception handler can handle the next exception.

7. A method for debugging a kernel-loadable program module, the method comprising the steps of:
receiving an exception while executing a kernel-loadable module;
determining whether the exception is caused by a breakpoint condition in the kernel-loadable module; and
in response to determining that the exception is caused by a breakpoint condition in the kernel-loadable module, changing the state of the kernel-loadable module to a suspended state while enabling other parts of the kernel to continue execution;
debugging the kernel-loadable module; and
subsequent to debugging the kernel-loadable module, restoring the state of the kernel-loadable module to a non-suspended state.

8. A method for replacing the kernel exception handler of a kernel-loadable operating system with a predetermined exception handler, without accessing kernel source code of the operating system, the method comprising the steps of:
identifying first and second patchpoints in the execution path of the kernel exception handler for installing branching code;
recording branching code at the first and second patchpoints for branching to the predetermined exception handler; and
recording branching code in the predetermined exception handler for branching back to the kernel exception handler at the first patchpoint.

9. A method for handling exceptions invoked in kernel space in a kernel-loadable operating system having a kernel exception handler, the method comprising the steps of:
in response to an exception event while executing a kernel-loadable module, which exception event indicates a requirement to suspend functions within the operating system kernel, changing the state of the kernel-loadable module to a suspended state while enabling the operating system kernel to continue execution; and processing the exception event using a replacement exception handler other than the kernel exception handler.

10. A data processing apparatus including a kernel-loadable operating system having a kernel exception handler, the apparatus comprising:
a debugger program for debugging kernel-loadable modules; and
means, responsive to a determination that an exception is caused by a breakpoint condition in the kernel-loadable module, for calling a suspend function to change the state of the kernel loadable module to a suspended state while enabling other parts of the kernel to continue execution, and for invoking a replacement exception handler and the debugger program to process the exception.

11. A data processing system according to claim 10, further comprising:
means, responsive to execution of the debugger program, for returning to a location in memory from which the exception originated; and
means for resuming execution of the kernel-loadable module.

12. A data processing apparatus according to claim 10, further comprising means for calling a suspend function to place the kernel-loadable module in a suspended state before the debugger program processes the exception, while enabling other parts of the kernel to continue execution.

13. A data processing apparatus according to claim 10, further comprising:
means for identifying first and second patchpoints in the execution path of the kernel exception handler, for installing branching code;
means for inserting branching code at the first and second patchpoints for branching to the predetermined exception handler; and
means for inserting branching code in the predetermined exception handler for branching back to the kernel exception handler at the first patchpoint.

14. A computer program product, comprising computer program code recorded on a machine-readable recording medium, for controlling the operation of a data processing apparatus on which the program code executes to perform a method according to claim 1.

15. A computer program product, comprising computer program code recorded on a machine-readable recording medium, for controlling the operation of a data processing apparatus on which the program code executes to perform a method according to claim 7.

16. A computer program product, comprising computer program code recorded on a machine-readable recording medium, for controlling the operation of a data processing apparatus on which the program code executes to perform a method according to claim 8.

17. A computer program product, comprising computer program code recorded on a machine-readable recording medium, for controlling the operation of a data processing apparatus on which the program code executes to perform a method according to claim 9.
